(19) United States
(12) Patent Application Publication
(10) Pub. No.: US 2010/0232056 A1
(43) Pub. Date: Sep. 16, 2010

(54) METHOD FOR MANUFACTURING MAGNETIC RECORDING MEDIUM, AND MAGNETIC RECORDING/REPRODUCING DEVICE

(75) Inventors: Masato Fukushima, Chiba (JP); Akira Sakawaki, Ichihara-shi (JP); Akira Yamane, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Minato-ku Tokyo (JP)

(21) Appl. No.: 12/679,463

(22) PCT Filed: Sep. 22, 2008
(86) PCT No.: PCT/JP2008/067083

§ 371 Date: Mar. 22, 2010

(30) Foreign Application Priority Data
Sep. 21, 2007 (JP) 2007 244754

(51) Int. Cl. G11B 5/596; G11B 5/84

(52) U.S. Cl. 360/77.02; 427/535; 216/22; G9B/5.216

(57) ABSTRACT

Provided is a process for manufacturing a magnetic recording medium having a magnetically partitioned magnetic recording patterns, which comprises the following steps, conducted in the order: (1) step of forming a magnetic layer on a non-magnetic substrate, (2) step of exposing the surface of regions of the magnetic layer to a reactive plasma or a reactive ion, which regions are to magnetically partition the magnetic layer for forming a magnetically partitioned magnetic recording pattern, and (3) step of exposing the magnetically partitioned magnetic layer to an inert gas irradiation. Preferably, a step of removing surface layer portions of said regions of the magnetic layer is carried out after the step (1) but before the step (2). The surface of the magnetic layer of produced magnetic recording medium exhibits good resistance to corrosion caused by oxidation or halogenation.

### TECHNICAL FIELD

This invention relates to a process for manufacturing a magnetic recording medium used for a magnetic recording/reproducing device such as a hard disk device.

### BACKGROUND ART

In recent years, magnetic recording apparatuses such as a magnetic disk apparatus, a flexible disk apparatus and a magnetic tape apparatus are widely used with their importance being increasing. Recording density of a magnetic recording medium used in the magnetic recording apparatus is greatly enhanced. Especially, since the development of MR head and PRMI, technique, the areal recording density is more and more increasing. Recently GMR head and TMR head have been developed, and the rate of increase in the areal recording density is about 100% per year. There is still increasing a demand for further enhancing the recording density, and therefore, a magnetic layer having a higher coercive force, and a higher signal-to-noise ratio (SNR) and a high resolution are eagerly desired.

An attempt of increasing the track density together with an increase of a liner recording density to enhance an areal recording density is also being made.

In a recent magnetic recording medium, the track density has reached about 110 kTPI. However, with an increase of the track density, magnetic recording information is liable to inferring with each other between adjacent tracks, and magnetization transition regions in the boundary regions thereof as a noise source tend to impair the SNR. These problems result in lowering in bit error rate and impede the enhancement of the recording density.

To enhance the areal recording density, it is required to render small the size of each recording bit and give the maximum saturated magnetization and magnetic film thickness to each recording bit. However, when the bit size is decreased, the minimum magnetization volume per bit becomes small, and the recorded data are tend to disappear due to magnetization reversal caused by heat fluctuation.

Further, in view of the reduction in distance between the adjacent tracks, a high-precision track servo system technology is required for the magnetic recording apparatus, and an operation is adopted wherein recording is carried out widely but the reproduction is carried out narrowly so that the influence of the adjacent tracks is minimized. This operation is advantageous in that the influence of the adjacent tracks can be minimized, but disadvantageous in that the reproduction output is rather low. This also leads to difficulty in enhancement of the SNR to a desired high level.

To reduce the heat fluctuation, maintain the desired SNR and obtain the desired reproduction output, a proposal has been made wherein ridges and grooves are formed on a magnetic recording medium so that each of patterned tracks on the ridges is partitioned by the grooves whereby the track density is enhanced. This type of magnetic recording media is hereinafter referred to as a discrete track media, and the technique for providing this type of magnetic recording media is hereinafter referred to as a discrete track method.

Further, an attempt is being made for dividing the data region in the same track, i.e., providing patterned media.

An example of the discrete track medium is a magnetic recording medium disclosed in patent document 1, which is made by providing a non-magnetic substrate having protrusions and depressions formed on the surface thereof, and the magnetic layer corresponding surface configuration is formed on the non-magnetic substrate, to give physically discrete magnetic recording tracks and servo signal patterns.

The magnetic recording medium in patent document 1 has a structure such that a ferromagnetic layer is formed via a soft magnetic underlayer on the non-magnetic substrate having protrusions and depressions formed on the surface thereof, and an overcoat is formed on the ferromagnetic layer. The magnetic recording pattered regions form magnetic recording regions on the protrusions physically partitioned from the surrounding regions.

In the above-mentioned magnetic recording medium, the occurrence of ferromagnetic domain wall in the soft magnetic underlayer can be prevented or minimized and therefore the influence due to the heat fluctuation is reduced and the interfere between the adjacent signals is minimized with the result of provision of a magnetic recording medium having a large SNR.

The discrete track method includes two type of methods: a first type is drawn to a method wherein tracks are formed after the formation of a multilayer magnetic recording medium comprising several laminated films; and a second type is drawn to a method wherein patterns having protrusions and depressions are formed directly on a substrate or formed on a film layer for forming tracks thereon, and then a multilayer magnetic recording medium is made using the patterned substrate or the film layer (see, for example, patent document 2 and patent document 3).

Further, other discrete track methods have been proposed in patent document 4, patent document 5 and patent document 6. In these methods, a previously formed magnetic layer of a magnetic recording medium is, for example, subjected to an implantation of nitrogen ion or oxygen ion or irradiated with laser whereby the magnetic characteristics of regions partitioning magnetic tracks are selectively modified.

Patent document 1 JP 2004-164692 A1

Patent document 2 JP 2004-178793 A1

Patent document 3 JP 2004-178794 A1

Patent document 4 JP H5-205257 A1

Patent document 5 JP 2006-209952 A1

Patent document 6 JP 2006-309841 A1

### DISCLOSURE OF THE INVENTION

### Problems to be Solved by the Invention

For the production of the above-mentioned discrete truck media and patterned media, which have a magnetically partitioned magnetic recording pattern, there is often adopted a step of exposing a magnetic layer to a reactive plasma or a reactive ion using oxygen or a halogen. Such step includes, for example, the following means.

(1) Means for forming a magnetically partitioned pattern on the magnetic layer by ion milling using a reactive plasma or a reactive ion.

(2) Means for removing a resist formed on the magnetic layer by ion milling using a reactive plasma or a reactive ion.

(3) Means for forming a magnetically partitioned pattern on the magnetic layer by modifying the magnetic characteristics of divided regions of the magnetic layer by using a reactive plasma or a reactive ion.

Researches, made by the inventors, for the production of a magnetic recording medium including the above-mentioned step revealed that the surface of the magnetic recording layer is oxidized or halogenated by the reactive plasma or reactive ion using oxygen or a halogen, and the oxidation or halogenation of the magnetic layer leads to corrosion of a magnetic recording medium due to migration of magnetic grains such as cobalt grains contained in the magnetic layer.

An object of the present invention is to provide a magnetic recording medium characterized in that corrosion does not occur or occurs only to a minimized extent due to the oxidation or halogenation in the surface portion of the magnetic layer, and thus, the magnetic recording medium exhibits an enhanced environmental resistance.

### Means for Solving the Problems

To achieve the above-recited objects, the inventors have made extensive efforts and completed the present invention.

In accordance with the present invention, there are provided the following processes for making a magnetic recording medium.

[1] A process for manufacturing a magnetic recording medium having a magnetically partitioned magnetic recording pattern, characterized by comprising the following steps (1), (2) and (3), conducted in this order:

(1) a step of forming a magnetic layer on a non-magnetic substrate;

(2) a step of exposing the surface of regions of the magnetic layer to a reactive plasma or a reactive ion, which regions are to magnetically partition the magnetic layer for forming a magnetically partitioned magnetic recording pattern; and

(3) a step of exposing the thus-magnetically partitioned magnetic layer to an inert gas irradiation.

[2] A process for manufacturing a magnetic recording medium having a magnetically partitioned magnetic recording pattern, characterized by comprising the following steps (1), (2), (3) and

(4), conducted in this order:

(1) a step of forming a magnetic layer on a non-magnetic substrate;

(2) a step of removing surface layer portions of regions of the magnetic layer, which regions are to magnetically partition the magnetic layer for forming a magnetically partitioned magnetic recording pattern;

(3) a step of exposing the thus-exposed surface of regions of the magnetic layer, from which the surface layer portion thereof have been removed in step (2), to a reactive plasma or a reactive ion; and

(4) a step of exposing the thus-magnetically partitioned magnetic layer to an inert gas irradiation.

[3] The process for manufacturing a magnetic recording medium as mentioned above in [2], wherein the surface layer portions of said regions are removed by ion milling in step (2).

[4] The process for manufacturing a magnetic recording medium as mentioned above in [2] or [3], wherein the surface layer portions in said portions to be removed in step (2) have a thickness in the range of 0.1 nm to 15 nm.

[5] The process for manufacturing a magnetic recording medium as mentioned above in any one of [1] to [4], wherein the surface of said regions of the magnetic layer is exposed to a reactive plasma or a reactive ion to an extent such that the magnetic characteristics of said regions of the magnetic layer regions are deteriorated.

[6] The process for manufacturing a magnetic recording medium as mentioned above in [5], wherein the deterioration of the magnetic characteristics is reduction of the coercive force and residual magnetization.

[7] The process for manufacturing a magnetic recording medium as mentioned above in [5], wherein the deterioration of the magnetic characteristics is caused by demagnetization or amorphization.

[8] The process for manufacturing a magnetic recording medium as mentioned above in any one of [2] to [7], wherein the reactive plasma or the reactive ion contains an oxygen ion.

[9] The process for manufacturing a magnetic recording medium as mentioned above in any one of [1] to [7], wherein the reactive plasma or the reactive ion contains a halogen ion.

[10] The process for manufacturing a magnetic recording medium as mentioned above in [9], wherein the halogen ion is a halogen ion formed by introducing a halide gas into a reactive plasma, said halide gas being at least one halide gas selected from the group consisting of CF₄, SF₆, CHF₃, CCl₄ and KBr.

[11] The process for manufacturing a magnetic recording medium as mentioned above in any one of [1] to [10], wherein the inert gas used for the exposure to the inert gas irradiation is at least one inert gas selected from the group consisting of Ar, He and Xe.

[12] The process for manufacturing a magnetic recording medium as mentioned above in any one of [1] to [11], wherein the exposure to the inert gas irradiation is carried out by a method using at least one means selected from the group consisting of ion gun, induced coupled plasma (ICP), and reactive ion plasma (RIE).

[13] A process for manufacturing a magnetic recording medium having a magnetically partitioned magnetic recording pattern, characterized by comprising the following steps (1) through (8), conducted in this order:

(1) a step of forming a magnetic layer on a non-magnetic substrate;

(2) a step of forming a masking layer on the magnetic layer;

(3) a step of forming a resist layer on the masking layer;

(4) a step of forming on the resist layer a magnetic recording pattern for partitioning the magnetic layer into divided regions;

(5) a step of removing the masking layer and, if any, a residual resist layer, in the regions corresponding to the magnetic layer-partitioning regions in the magnetic recording pattern;

(6) a step of exposing the thus-exposed surfaces of magnetic layer, from which the masking layer and the residual resist layer in said regions of magnetic layer have been removed in step (5), to a reactive plasma or a reactive ion, whereby a magnetic recording pattern is formed which is magnetically partitioned by said regions of magnetic layer;

(7) a step of removing the whole residual masking layer; and

(8) a step of exposing said regions of magnetic layer to an inert gas irradiation.

[14] A process for manufacturing a magnetic recording medium having a magnetically partitioned magnetic recording pattern, characterized by comprising the following steps (1) through (9), conducted in this order:

(1) a step of forming a magnetic layer on a non-magnetic substrate;

(2) a step of forming a masking layer on the magnetic layer;

(3) a step of forming a resist layer on the masking layer;

(4) a step of forming on the resist layer a magnetic recording pattern for partitioning the magnetic layer into divided regions;

(5) a step of removing the masking layer and, if any, a residual resist layer, in the regions corresponding to the magnetic layer-partitioning regions in the magnetic recording pattern;

(6) a step of removing the surface layer portions in said regions of the magnetic layer, from which the masking layer and the residual resist layer have been removed in step (5).

(7) a step of exposing the thus-exposed surface in the regions of the magnetic layer, from which the surface layer portion thereof have been removed in step (6), to a reactive plasma or a reactive ion, whereby a magnetic recording pattern is formed which is magnetically partitioned by said regions of magnetic layer;

(8) a step of removing the whole residual masking layer; and

(9) a step of exposing said regions of magnetic layer to an inert gas irradiation.

[15] The process for manufacturing a magnetic recording medium as mentioned above in any one of [1] to [14], which further comprises a step of forming a protective overcoat over the exposed surface after the exposure of said regions of magnetic layer to an inert gas irradiation.

In accordance with the present invention, there is further provided the following magnetic recording reproducing apparatus.

[16] A magnetic recording reproducing apparatus characterized by comprising, in combination, the magnetic recording medium manufactured by the process as mentioned above in any one of [1] to [15]; a driving part for driving the magnetic recording medium in the recording direction; a magnetic head comprising a recording part and a reproducing part; means for moving the magnetic head in a relative motion to the magnetic recording medium; and a recording-and-reproducing signal treating means for inputting signal to the magnetic head and for reproduction of output signal from the magnetic head.

### EFFECT OF THE INVENTION

According to the present invention, a magnetic recording medium can be provided which is characterized in that migration of magnetic grains such as cobalt grains does not occur or occurs only to a minimized extent in the magnetic layer, and thus, which exhibits an enhanced environmental resistance.

### BRIEF DESCRIPTION OF THE DRAWINGS

FIG. 1 is a flow-sheet of the first-half steps for producing a magnetic recording medium according to the present invention.

FIG. 2 is flow-sheet of the second-half steps for producing a magnetic recording medium according to the present invention.

FIG. 3 is a schematic illustration of the magnetic recording-reproducing apparatus of the present invention.

FIG. 4 is a graph showing corrosion characteristics, i.e., a relation between Ar irradiation time and Co corrosion, obtained in the examples and the comparative examples.

FIG. 5 is a graph showing electromagnetic conversion characteristics, i.e., a relation between Ar irradiation time and signal-noise ratio, obtained in the examples and the comparative examples.

### REFERENCE NUMERALS

1 Non-magnetic substrate
2 Magnetic layer
3 Masking layer
4 Resist layer
5 Stamp
6 Milling ion
7 Region from which surface layer portion of the magnetic layer have been partially removed
d: Depth of the region from which surface layer portion of the magnetic layer has been partially removed, i.e., thickness of the removed surface layer portion of the magnetic layer.
8. Region of the magnetic layer, having modified magnetic characteristics
9 Protective overcoat
10 Reactive plasma or reactive ion
11 Inert gas
100 Magnetic recording medium
101 Medium-driving part
102 Magnetic head
103 Head driving part
104 Recording-reproducing signal system

### BEST MODE FOR CARRYING OUT THE INVENTION

The present invention is concerned with a process for manufacturing a magnetic recording medium having a magnetically partitioned magnetic recording pattern, which is characterized by comprising the following steps (1), (2) and (3), conducted in this order: (1) a step of forming a magnetic layer on a non-magnetic substrate; (2) a step of exposing the surface of regions of the magnetic layer to a reactive plasma or a reactive ion, which regions are to magnetically partition the magnetic layer for forming a magnetically partitioned magnetic recording pattern; and (3) a step of exposing the thus-magnetically partitioned magnetic layer to an inert gas irradiation. Preferably, the process according to the present invention comprises the following steps (1), (2), (3) and (4), conducted in this order: (1) a step of forming a magnetic layer on a non-magnetic substrate; (2) a step of removing surface layer portions of regions of the magnetic layer, which regions are to magnetically partition the magnetic layer for forming a magnetically partitioned magnetic recording pattern; (3) a step of exposing the thus-exposed surface of regions of the magnetic layer, from which the surface layer portion thereof have been removed in step (2), to a reactive plasma or a reactive ion; and (4) a step of exposing the thus-magnetically partitioned magnetic layer to an inert gas irradiation.

The magnetic recording medium made by the process of the present invention has a magnetically partitioned magnetic recording pattern, and regions for magnetically partitioning the magnetic recording pattern. The regions for magnetically partitioning the magnetic recording pattern are formed by conducting a step of modifying magnetic characteristics of said regions for magnetically partitioning the magnetic recording pattern by exposing said regions to a reactive plasma or a reactive ion, preferably after surface layer portions of said regions of the magnetic layer are removed. Thereafter the magnetic layer is exposed to an inert gas irradiation.

Researches, made by the inventors, on the production of a magnetic recording medium including the above-mentioned step revealed that the surface of the magnetic recording layer is oxidized or halogenated by the reactive plasma or reactive ion using oxygen or a halogen, and thus, the exposed surface of the magnetic layer is activated, and consequently, the environmental resistance of a magnetic recording medium becomes deteriorated, if said surface is not irradiated with an inert gas irradiation. More specifically, the magnetic metal grains such as cobalt grains, activated by the oxidation or halogenation of the magnetic layer by the reactive plasma or reactive ion, tend to migrate and partly protrude from the surface of carbon overcoat under high-temperature and high-humidity conditions, and occasionally cause injury to a head of a hard disk drive.

In the production process according to the present invention, the magnetic layer, which has been activated by the oxidation or halogenation with the reactive plasma or reactive ion, is exposed to an inert gas irradiation, and consequently, the magnetic layer is stabilized and the migration of magnetic metal grains does not occur or occurs only to the minimum extent under high-temperature and high-humidity conditions.

By the term “magnetic recording pattern” as used in this specification is meant a magnetic recording pattern in a broad sense which include patterned media wherein magnetic recording patterns are arranged with a certain regularity per bit; media wherein magnetic recording patterns are arranged in tracks fashion; and servo signal patterns.

The process of the present invention is preferably adopted for the manufacture of a discrete type magnetic recoding medium in view of simplicity and ease, wherein the magnetically partitioned magnetic recording pattern involves magnetic recoding tracks and servo signal patterns.

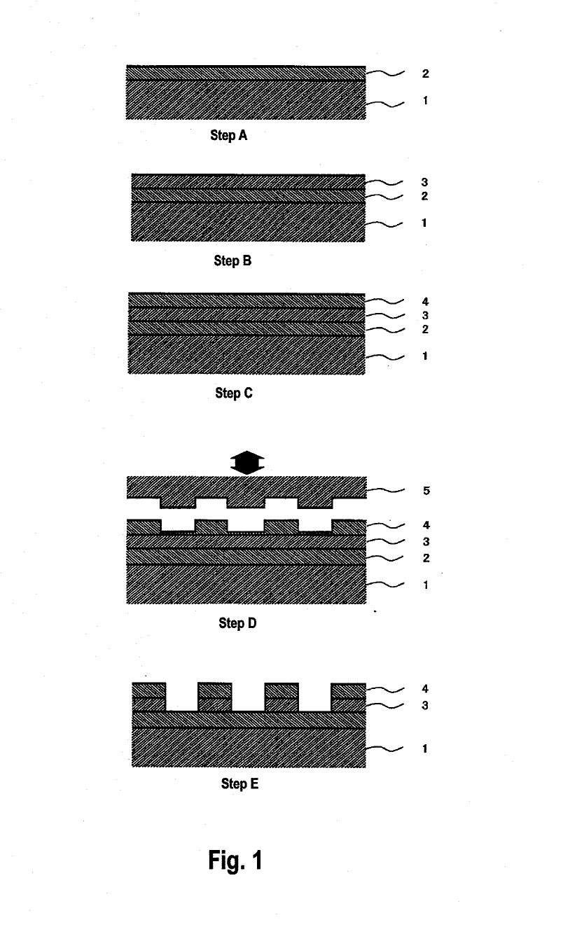

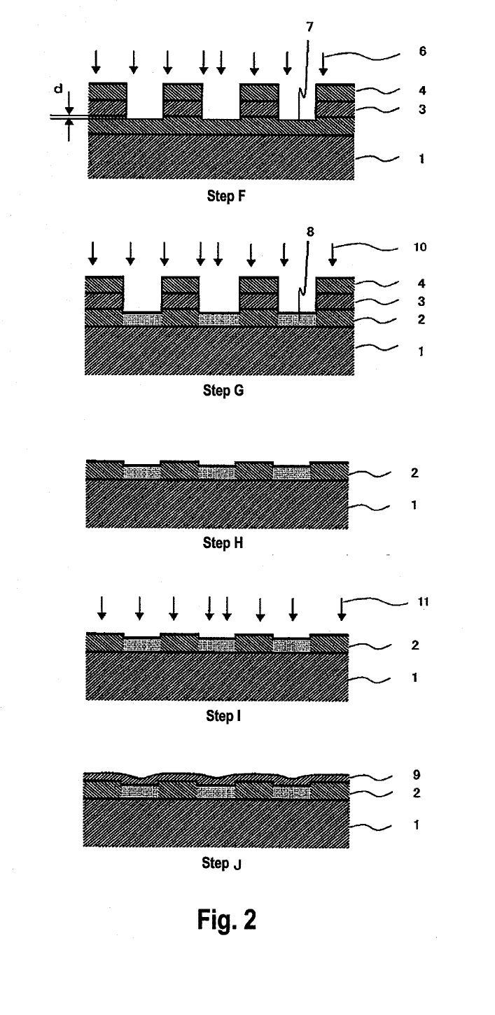

The process for making the magnetic recording medium according to the present invention will be specifically described with reference to the accompanying FIG. 1 and FIG. 2.

The magnetic recording medium made has a multi-layer structure as illustrated in, for example, step J in FIG. 2 which comprises a non-magnetic substrate 1, a magnetic layer 2 formed on the substrate and having a magnetic recording pattern, and an overcoat 9, which are formed in this order. In the magnetic recording medium produced by the process of the present invention, optional layers other than a non-magnetic substrate 1, a magnetic layer 2 and an overcoat 9 can be appropriately arranged according to the need. Thus, a soft magnetic underlayer and an intermediate layer (which are not shown in FIG. 2) may be formed between the non-magnetic substrate 1 and the magnetic layer 2. A lubricating film (not shown in FIG. 2) may be formed on the overcoat.

The non-magnetic substrate 1 used in the present invention is not particularly limited, and, as specific examples thereof, there can be mentioned aluminum alloy substrates predominantly comprised of aluminum such as, for example, an Al—Mg alloy substrate; and substrates made of ordinary soda glass, aluminosilicate glass, glass ceramics, silicon, titanium, ceramics, and resins. Of these, aluminum alloy substrates, glass substrates such as glass ceramics substrate, and silicon substrate are preferably used.

The non-magnetic substrate preferably has an average surface roughness (Ra) of not larger than 1 nm, more preferably not larger than 0.5 nm, and especially preferably not larger than 0.1 nm.

The magnetic layer 2 formed on the non-magnetic substrate 1 may be either an in-plane magnetic layer or a perpendicular magnetic layer. A perpendicular magnetic layer is preferable in view of more enhanced recording density.

The magnetic layer is preferably formed from an alloy predominantly comprised of cobalt.

A preferable example of the in-plane magnetic layer is a combination of a ferromagnetic CoCrPtTa layer with a non-magnetic CrMo underlayer.

A preferable example of the perpendicular magnetic layer has a laminate structure which is a combination of a soft magnetic underlayer comprised of a FeCo alloy such as FeCoB, FeCoSiB, FeCoZr, FeCoZrB or FeCoZrBCu; a FeTa alloy such as FeTaN or FeTaC; or a Co alloy such as CoTaZr, CoZrNB or CoB; an orientation-controlling layer comprised of Pt, Pd, Ni, Cr or NiFeCr; an optional intermediate R^{u} layer; and a ferromagnetic layer comprised of a 60Co-15Cr-15Pt alloy or a 70Co-5Cr-15Pt-10SiO₂ alloy (the numeral occurring immediately before each element refers to % by mole of the element).

Usually the magnetic layer is formed as a film form by sputtering.

The magnetic layer usually has a thickness in the range of 3 nm to 20 nm, preferably 5 nm to 15 nm. The magnetic layer is formed so that sufficiently high input and output head powers can be obtained in consideration of the kind of magnetic alloy and the laminar structure. The magnetic layer has a thickness of at least certain value so as to obtain an output power of at least certain level at reproduction. However, parameters relating to the recordation-reproduction characteristics are generally deteriorated with an increase of the output power. Therefore an optimum thickness of magnetic layer is preferably chosen in consideration of the output power and the recordation-reproduction characteristics.

The process for producing the magnetic recording medium according to the present invention as specifically exemplified in FIG. 1 and FIG. 2 comprises the following steps A through J.

Step A of forming at least magnetic layer 2 on a non-magnetic substrate 1.

Step B of forming a masking layer 3 on magnetic layer 2.

Step C of forming a resist layer 4 on masking layer 3.

Step D of transferring a negative magnetic recording pattern onto the resist layer 4 by using a stamp 5. The arrow in FIG. 1 refers to the direction in which the stamp 5 moves.

Step E of selectively removing the regions of the masking layer 3, which are depressions corresponding to the negative magnetic recording patterns of the magnetic recording pattern. In the case when the resist layer partially remains in the depression regions in step D, the residual resist layer 4 and the masking layer 3 in the depression are removed in step E.

Step F of partially ion-milling 6 the depression regions of the surface layer of magnetic layer 2, corresponding to the regions from which masking layer 3 is partially removed, and removing the ion-milled regions. Reference numeral 7 indicates the ion-milled regions of the surface layer of magnetic layer, and reference letter d indicates the thickness of the surface layer portions of magnetic layer which have been removed by ion-milling.

Step G of exposing the ion-milled regions 7 of the magnetic layer, from which the surface layer portions of magnetic layer have been removed, to a reactive plasma or a reactive ion 10, thereby modifying the magnetic characteristics of said regions 7 of magnetic layer. Reference numeral 8 indicates the regions of the magnetic layer which have modified magnetic characteristics.

Step H of removing resist layer 4 and masking layer 3.

Step I of exposing the magnetic layer 2, from which resist layer 4 and masking layer 3 have been removed, to an inert gas irradiation.

Step J of covering the surface of the magnetic layer 2 with a protective overcoat 9.

The above-mentioned steps A through J are carried out in the above-recited order.

Step F, partially ion-milling 6 the depression regions of the surface layer of magnetic layer 2, is not essential, but is preferably carried out. In the case when the ion-milling step F is omitted, the surface of magnetic layer which is exposed by the removal of masking layer 3 in step E is exposed to a reactive plasma or a reactive ion in step G.

The masking layer 3, formed on the magnetic layer 2 in the step B in the process for producing the magnetic recording medium according to the present invention, is formed preferably from at least one material selected from Ta, W, Ta nitride, W nitride, Si, SiO₂, Ta₂O₅, Re, Mo, Ti, V, Nb, Sn, Ga, Ge, As and Ni. By using these materials, the shieldability of the masking layer 3 against milling ion 6 can be enhanced and the formability of the magnetic recording pattern by the masking layer 3 can also be enhanced. These materials can easily be removed at dry etching step using reactive gas, and therefore, in the step H shown in FIG. 2, residual masking layer can be minimized and staining of the exposed surface of magnetic recording medium layer can be avoided or minimized.

Among the masking layer-forming materials used in the masking layer-forming step B, As, Ge, Sn and Ga are preferable. Ni, Ti, V and Nb are more preferable, and Mo, Ta and W are most preferable.

The masking layer preferably has a thickness in the range of 1 nm to 20 nm.

When negative magnetic recording pattern is transferred onto the resist layer 4, formed in the step C, by using a stamp 5 as illustrated in the step D, the stamping is preferably carried out under conditions such that the regions of the resist layer 4, pressed by the stamping, have a thickness in the range of 0 to 10 nm. By carrying out the stamping under such conditions, when the regions of the masking layer 3, corresponding to the negative magnetic recording pattern of magnetic recording pattern, are selectively removed by etching in the step E, the etching can be effected in an advantageous manner. That is, undesirable sagging at edge portions of the masking layer 3 can be avoided and the shieldability of the masking layer 3 against milling ion 6 can be enhanced in step F in FIG. 2, and the formability of the magnetic recording pattern by the masking layer 3 also is enhanced.

The resist layer usually has a thickness in the range of about 10 nm to about 100 nm.

In a preferred embodiment of the process for manufacturing a magnetic recording medium according to the present invention, as the material for forming the resist layer 4 in the step C in FIG. 1, a material which can be cured upon irradiation with radiation is used; and, when negative magnetic recording pattern is transferred onto the resist layer 4 by using a stamp 5 in the step D, or after the transfer of negative magnetic recording pattern has been completed, the resist layer 4 is irradiated with radiation. In this preferred embodiment, the configuration of stamp 5 can be transferred on the resist layer 4 with high precision. Consequently, when the regions of the masking layer 3, corresponding to the negative magnetic recording pattern of the magnetic recording pattern, are removed by etching in the step E in FIG. 1, undesirable sagging at edge portions of the masking layer 3 can be avoided and the shieldability of the masking layer 3 against milling ion 6 can be enhanced, and the formability of the magnetic recording pattern by the masking layer 3 can also be enhanced.

The radiation used for curing the curable material refers to electromagnetic waves in a broad sense which include heat rays, visible light, ultraviolet light, X rays and gamma rays. The curable material includes thermosetting resins which are curable by heat rays, and ultraviolet-setting resins which are curable by ultraviolet light.

In the process for producing the magnetic recording medium of the present invention, in the step D of transferring negative magnetic recording patterns onto the resist layer 4 by using stamp 5, it is preferable that the stamp is pressed on the resist layer 4 having high fluidity, and, while the resist layer is in the pressed state, the resist layer 4 is irradiated with radiation to be thereby cured, and thereafter the stamp 5 is removed from the resist layer 4. By this procedure, the configuration of the stamp can be transferred to the resist layer 4 with a high precision.

For irradiating the resist layer having high fluidity with radiation while the resist layer is in the pressed state, there can be adopted a method of irradiating a laminate structure comprising the resist layer with radiation by exposing the substrate side (i.e., side opposite to the stamp-pressed resist layer) of the laminate structure to radiation; a method of using a radiation-transmitting stamp, and exposing the stamp-pressed side of the laminated structure to radiation; a method of exposing the stamp-pressed resist layer to radiation by applying radiation from side of the laminate structure; and a method of using radiation exhibiting a high conductivity to a solid, such as heat rays, and exposing the stamp-pressed side of the laminate structure or the opposite side (substrate side) thereof, with the highly thermoconductive radiation.

In a preferred specific example of the procedure of irradiating the radiation-curable resist layer with radiation to cure the resist layer, an ultraviolet ray-curable resin such as novolak resin, an acrylic acid ester resin or a cycloaliphatic epoxy resin is used as the radiation-curable resist resin, and a stamp made of a highly ultraviolet ray-transmitting glass or resin is used.

By adopting the above-mentioned procedures, the magnetic characteristics such as, for example, the coercive force and the residual magnetization in the regions of partitioning the magnetic tracks can be reduced to the minimum values, and consequently, the letter bleeding at writing can be avoided and the plane recording density of the magnetic recording medium can be enhanced to greater extent.

The stamp used in the pattern-transferring step D is preferably made by forming minute track patterns on a metal plate, for example, by electron beam lithography. The material used for forming the stamp is not particularly limited, provided that the purpose of the invention is not impaired, but, a material having a hardness sufficient for enduring over the process for producing the magnetic recoding medium, and having good durability, is preferably used. Such material includes, for example, nickel.

The patterns formed on the stamp include those which are conventionally used tracks for recording ordinary data, and further include patters for servo signal, such as burst patterns, gray code patterns and preamble patterns.

As illustrated in the step F in FIG. 2, the surface layer portions in the depression regions of the magnetic layer are preferably removed by, for example, ion-milling, and thereafter, the newly exposed regions are exposed to a reactive plasma or a reactive ion, whereby the magnetic characteristics of said regions are modified. The magnetic recording medium having such regions having modified magnetic characteristics has magnetic recording patterns exhibiting clear contrast and has a high SNR, as compared with those of the conventional magnetic recording medium which does not have regions with modified magnetic characteristics, and which has been prepared by a method wherein the surface layer portions in the depression regions of magnetic layer are not removed and the exposure of said regions to a reactive plasma or a reactive ion is not carried out. This would be for the following reasons. First, by the removal of the surface layer portions in the regions of magnetic layer, the newly exposed regions are clear and activated, and therefore, exhibit enhanced reactivity with a reactive plasma and a reactive ion; and secondly, surface defects such as minute voids are formed in the newly exposed regions into which a reactive plasma or ion can be easily penetrated.

The thickness, as expressed by “d” in step F in FIG. 2, in the depression regions of the surface layer of magnetic layer to be removed by, for example, ion-milling, is preferably in the range of 0.1 nm to 15 nm, more preferably 1 nm to 10 nm. When the thickness of the removed regions is smaller than 0.1 nm, the above-mentioned benefits brought about by the removal of said regions are insufficient. In contrast, when the thickness of the removed regions is larger than 15 nm, the resulting magnetic recording medium has a poor surface smoothness and the magnetic recording-reproducing apparatus has a poor head-floating property.

In the present invention, the regions of the magnetic layer, which magnetically partition, for example, the magnetic recording tracks and servo signal patterns from each other are exposed to a reactive plasma or a reactive ion whereby the magnetic characteristics of the regions of magnetic layer are modified or degraded.

By the term “magnetically partitioned magnetic recording pattern” as used in the present specification is meant, as illustrated in FIG. 2, step G, the magnetic recording pattern which is partitioned by the modified or demagnetized regions 8 of the magnetic layer 2 as seen when the laminated structure is viewed from the front side. The object of the present invention can be achieved in an embodiment wherein, in the case when the magnetic layer 2 is partitioned by the modified or demagnetized regions 8 thereof in the upper surface portion of the magnetic layer 2, even though the magnetic layer 2 is not partitioned in the lowermost portion thereof. Therefore this embodiment also falls within the scope of the magnetically partitioned magnetic recording pattern as herein used.

By the term “magnetic recording pattern” as used herein is meant a magnetic recording pattern in a broad sense which include patterned media wherein magnetic recording patterns are arranged with a certain regularity per bit; media wherein magnetic recording patterns are arranged in tracks fashion; and servo signal patterns.

The process of the present invention is preferably adopted for the manufacture of a discrete type magnetic recoding medium in view of simplicity and ease, wherein the magnetically partitioned magnetic recording pattern involves magnetic recoding tracks and servo signal patterns.

The modification of the magnetic layer as conducted for forming the magnetic recording pattern in the present invention refers to at least partially changing the magnetic characteristics (more specifically, lowering the coercive force and residual magnetization) of the magnetic layer in specified regions thereof for the formation of magnetic recording pattern.

The above-mentioned regions of the magnetic layer, which magnetically partition, for example, the magnetic recording tracks and servo signal patterns from each other, can be formed by amorphization of the specific regions by exposure to a reactive plasma or a reactive ion. Thus, the magnetic characteristics of the regions of magnetic layer can be modified also by changing the crystalline structure of the magnetic layer (more specifically, by amorphization of the magnetic layer) in specified regions thereof by exposing said specified regions to a reactive plasma or a reactive ion for the formation of the regions for magnetically partitioning the magnetic recording tracks and servo signal patterns.

The amorphization of the magnetic layer in the present invention refers to that the atomic arrangement in the magnetic layer is changed to an irregular atomic arrangement with no long-distance order. More specifically it refers to that microcrystalline particles having a size of smaller than 2 nm are arranged in random. This arrangement in random of the microcrystalline particles can be confirmed by the absence of peaks attributed to the crystalline plane or by the presence of halo alone by X-ray diffraction analysis or electron-ray diffraction analysis.

The reactive plasma as used in the present invention includes, for example, inductively coupled plasma (ICP) and reactive ion plasma (RIP). The reactive ion as used in the present invention includes, for example, reactive ions present in the above-mentioned inductively coupled plasma and reactive ion plasma.

The inductively coupled plasma as used herein refers to a high-temperature plasma which is obtained by imposing a high voltage to a gas to thereby form plasma, and further applying magnetic variation at a high frequency to generate joule heat due to over-current inside the plasma. The inductive coupled plasma has a high electron density, and, can modify the magnetic characteristics of magnetic layer with a high efficiency in a broad-area magnetic film, as compared with the case of making discrete track media conventionally using an ion beam.

The reactive ion plasma as used herein refers to a highly reactive plasma which is obtained by adding a reactive gas such as O₂, SF₆, CHF₃, CF₄ or CCl₄ in a plasma. When such reactive ion plasma having a reactive gas added is used in the process of the present invention, said plasma can modify the magnetic characteristics of the magnetic layer with a higher efficiency.

In the process of the present invention, the magnetic characteristics of the magnetic layer are modified by exposing the magnetic layer to the reactive plasma. This modification is effected preferably by the reaction of magnetic metal constituting the magnetic layer with an atom or an ion within the reactive plasma. The reaction of the magnetic metal with the atom or ion is accompanied by, for example, penetration of atoms of the reactive plasma into the magnetic metal with the results of modification of the crystalline structure of the magnetic metal, change of the composition of the magnetic metal, and oxidation, nitridation and/or silicification of the magnetic metal.

A reactive plasma containing oxygen atoms is preferably used as the reactive plasma in the present invention whereby the magnetic metal constituting the magnetic layer is allowed to react with the oxygen atoms within the reactive plasma to oxidize specified regions of the magnetic layer. By the oxidation of the specific regions of magnetic layer, the residual magnetization and the coercive force can be reduced with more enhanced efficiency. That is, the magnetic recording medium having magnetically partitioned magnetic recording pattern can be made by a reactive plasma treatment of a short time.

Thus, the modification of the regions for partitioning the magnetic layer, for example, by a reactive plasma as conducted for forming the magnetic recording pattern in the present invention includes changing or lowering the magnetic characteristics, more specifically, lowering the coercive force and residual magnetization of the specific regions of magnetic layer, and demagnetization or amorphization of the specific regions of magnetic layer.

A reactive plasma containing a halogen ion is also preferably used as the reactive plasma in the present invention. As the halogen ion, a fluorine ion is especially preferable.

The halogen ion may be present either alone or as a combination thereof with an oxygen ion in the reactive plasma. As mentioned above, the magnetic characteristics of the magnetic layer can be modified with an enhanced efficiency by the reaction of the oxygen ion in the reactive plasma with the magnetic metal constituting the magnetic layer, and, the efficiency of modification can be far improved by the combination of the oxygen ion with the halogen ion in the reactive plasma.

Even in the case when the reactive plasma contains a halogen ion but does not contain an oxygen ion, the halogen ion reacts with the magnetic metal in the magnetic layer to modify the magnetic characteristics of the magnetic layer. The reason for which is not clear, but it is presumed that the halogen ion in the reactive plasma etches foreign matter deposited on the surface of the magnetic layer to make clean the surface of the magnetic layer with the result of enhancement of the reactivity of the magnetic layer. Further the clean surface of the magnetic layer is presumed to react the halogen ion with a high efficiency. This beneficial effect is especially markedly obtained when a fluorine ion is used as the halogen ion.

After the modification of the specific regions of the magnetic layer is carried out, the resist layer 4 and the masking layer 3 are removed as illustrated in the step H in FIG. 2. The removal of the resist layer 4 and the masking layer 3 can be carried out by, for example, a procedure of dry etching, reactive ion etching, ion milling or wet etching.

After the removal of the resist layer 4 and the masking layer 3, the magnetic layer having been activated in the steps F, G and H in FIG. 2 is exposed to an inert gas irradiation in the step I, whereby the magnetic layer is stabilized, and occurrence of the migration of magnetic grains is avoided or minimized even under high-temperature and high-humidity conditions. The reason for which such benefits are obtained by the exposure to an inert gas irradiation is not clear. But, it is presumed that the inert element intrudes into the surface layer portion of the magnetic layer and consequently the migration of magnetic grains can be suppressed, and further that the surface layer portion activated by inert gas irradiation is removed and the migration of magnetic grains does not occur or occurs only to a minor extent.

As the inert gas, at least one gas selected from the group consisting of Ar, He and Xe is preferably used in view of the stability and the enhanced effect of suppressing the migration of magnetic grains.

The exposure to the inert gas irradiation is carried out preferably by a method using at least one means selected from the group consisting of ion gun, induced coupled plasma (ICP), and reactive ion plasma (RIE). Of these, ICP and RIE are preferable in view of enhanced intensity of irradiation. The ICE and the RIE are hereinbefore described.

After the exposure to an inert gas irradiation, a protective over coat 9 is preferably formed on the surface of the magnetic layer as illustrated in FIG. 2, step J, and then a lubricant (not shown in FIG. 2) is preferably coated on the protective overcoat.

The formation of the overcoat 9 can usually be effected by forming a diamond-like-carbon film by, for example, using P-CVD, but the method for forming the overcoat is not particularly limited.

The protective overcoat 9 can be formed from materials conventionally used for forming a protective overcoat, which include, for example, carbonaceous materials such as carbon (C), hydrogenated carbon (HₓC), nitrided carbon (CN), amorphous carbon and silicon carbide (SiC); and SiO₂, Zr₂O₃ and TiN. Two or more overcoats may be formed.

The thickness of the overcoat 9 is below 10 nm. If the thickness of the protective layer is larger than 10 nm, the distance between the head and the magnetic layer becomes undesirably large and the input and output powers are often insufficient.

A lubricating layer is preferably formed on the overcoat 9.

The lubricating layer is formed from, for example, a fluorine-containing lubricant, a hydrocarbon lubricant or a mixture thereof. The thickness of the lubricating layer is usually in the range of 1 to 4 nm.

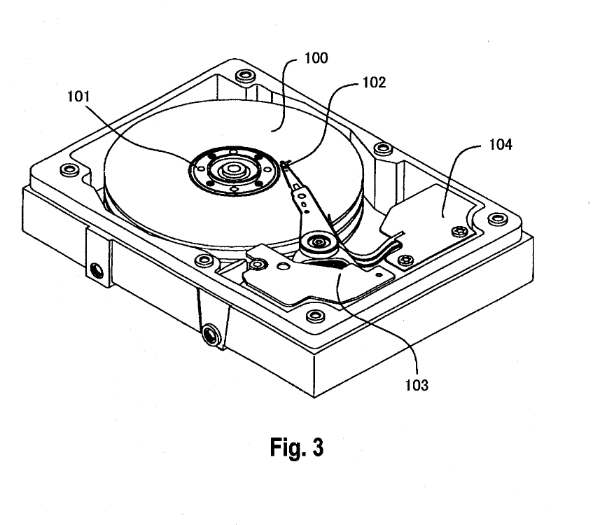

The constitution of an example of the magnetic recording-reproducing apparatus according to the present invention is illustrated in FIG. 3. The magnetic recording-reproducing apparatus of the present invention comprises, in combination, the above-mentioned magnetic recording medium 100 of the invention; a driving part 101 for driving the magnetic recording medium in the recording direction; a magnetic head 102 comprising a recording part and a reproducing part; means (head-driving part 103) for moving the magnetic head 102 in a relative motion to the magnetic recording medium 100; and a recording-and-reproducing signal treating means 104 for inputting signal into the magnetic head 102 and for reproduction of output signal from the magnetic head 102.

The magnetic recording-reproducing apparatus comprising the combination of the above-mentioned means can provide a high recording density. More specifically, in the magnetic recording medium of the magnetic recording-reproducing apparatus, the magnetic recording tracks are magnetically discrete, and therefore, the recording head width and the reproducing head width can be approximately the same size as each other with the result of sufficiently high reproducing output power and SNR. This is in a striking contrast to the conventional magnetic recording medium wherein the reproducing head width must be smaller than the recording head width to minimize the influence of the magnetization transition regions in the track edges.

By constituting the reproducing part of the magnetic head as GMR head or TMR head, a sufficiently high signal intensity can be obtained even at a high recording density, that is, the magnetic recording apparatus having a high recording density can be provided.

When the head is floated at a floating height in the range of 0.005 μm to 0.020 μm, which is lower than the conventionally adopted floating height, the output power is increased and the SNR becomes large, and thus the magnetic recording apparatus can have a large size and a high reliability.

If a signal treating circuit using a sum-product composite algorithm is combined in the magnetic recording medium, the recording density can be much more enhanced, and a sufficiently high SNR can be obtained even when recordation-reproduction is carried out at a high recording density of at least 100 G-bit or more per square inch, a track density of 100 k-tracks or more per inch, or a linear recording density of 1000 k-bit or more per inch.

### EXAMPLES

The invention will now be specifically described by the following examples.

### Example 1

A glass substrate for HD was placed in a vacuum chamber and the chamber was vacuumed to a pressure of not higher than 1.0×10⁻⁵ Pa to remove the air. The glass substrate used is comprised of glass ceramics having a composition of Li₂Si₂O₅, Al₂O₃-K₂O, Al₂O₃, -K₂O, MgO—P₂O₅ and Sb₂O₃-ZuO, and has an outer diameter of 65 mm and an inner diameter of 20 mm, and an average surface roughness (Ra) of 2 angstroms.

On the glass substrate, a soft magnetic underlayer composed of 65Fe-30Co-5B, an intermediate layer composed of Ru and a magnetic layer composed of 70Co-5Cr-15Pt-10SiO₂ alloy (the numerals indicate ratio by mole) were formed in this order by DC sputtering. The thicknesses of respective layers are: FeCoB soft magnetic underlayer: 600 nm, Ru intermediate layer: 100 nm, and magnetic layer: 150 nm.

A masking layer composed of Ta with a thickness of 60 nm was formed on the laminated structure by sputtering. Then a resist layer composed of ultraviolet ray-curable novolak resin with a thickness of 100 nm was formed on the masking layer by spin-coating.

A glass stamp having a negative pattern corresponding to the desired magnetic recording pattern was pressed to the resist layer at a pressure of 1 MPa (about 8.8 kgf/cm²). The glass of the stamp had an ultraviolet-ray transmission of at least 95%. In the-thus pressed state, the pressed upper side of the resist layer was irradiated with ultraviolet rays with a wavelength of 250 nm for 10 seconds to cure the resist layer. Thereafter the stamp was separated from the cured resist layer thereby transferring magnetic recording pattern on the resist layer. The thus-transferred magnetic recording pattern had a configuration such that the protrusions in the resist layer are circular with a width of 120 nm, and the depressions in the resist layer are circular with a width of 60 nm. The thickness of the resist layer was 80 nm and the thickness of the depressed portions of the resist layer was about 5 nm. The depressed portions had an angle of about 90 degrees to the substrate surface.

Thereafter, the pressed depressed portions of the resist layer and the corresponding portions of the Ta masking layer were removed by dry etching. The dry etching conditions for etching the resist layer were as follows. O₂ gas: 40 sccm, pressure: 0.3 Pa, high-frequency plasma power: 300 W, DC bias: 30 W, and etching time: 10 seconds. The dry etching conditions for etching the Ta masking layer were: CF₄ gas: 50 sccm, pressure: 0.6 Pa, high-frequency plasma power: 500 W, DC bias: 60 W, and etching time: 30 seconds.

Then exposed regions of the magnetic layer which were not covered by the masking layer were removed by ion milling using an argon ion. The ion-milling conditions were as follows. High-frequency plasma power: 800 W, accelerating voltage: 500 V, pressure: 0.014 Pa, flow rate of Ar: 5 sccm, treating time: 40 sec, and current density: 0.4 mA/cm².

Then the regions exposed by the ion milling were exposed to a reactive plasma whereby the magnetic characteristics of said regions of the magnetic layer were modified. This modification using a reactive plasma was carried out by using an inductively coupled plasma apparatus “NE550” available from Ulvac, Inc. The plasma was generated by O₂ gas at a flow rate of 90 cc/minute. The input power for plasma generation was 200 W, the pressure within the apparatus was 0.5 Pa and the treating time for the magnetic layer was 300 seconds.

Thereafter the resist layer and the masking layer were removed by dry etching. The dry etching conditions were as follows. Flow rate of SF₆ gas: 100 sccm, pressure: 2.0 Pa, high-frequency plasma power: 400 W, and treating time: 300 sec.

Thereafter the surface of the magnetic layer was exposed with an inert gas plasma irradiation. The conditions for the inert gas plasma irradiation were as follows. Flow rate of Ar inert gas: 5 sccm, pressure: 0.014 Pa, accelerating voltage: 300 V, current density: 0.4 mA/cm², and treating time: 5, 10, 15 or 25 sec.

The thus-treated upper surface was covered with a carbon overcoat having a thickness of 4 nm by a CVD method using diamond-like-carbon (DLC). Further, the upper surface of the overcoat was coated with a lubricating material to give a magnetic recording medium.

### Comparative Example 1

By substantially the same procedures and conditions as employed in Example 1, a magnetic recording medium was manufactured wherein the irradiation with inert gas plasma of the magnetic layer was not carried out. All other conditions remaining the same.

### Examples 2 to 6

By substantially the same procedures and conditions as employed in Example 1, magnetic recording mediums were made wherein the inert gas used and the treating time were changed as shown in Table 1, below. All other conditions remained the same.

The inert gas used and the irradiation time with the inert gas plasma in Examples 1-6 and Comparative Example 1 are shown in Table 1.

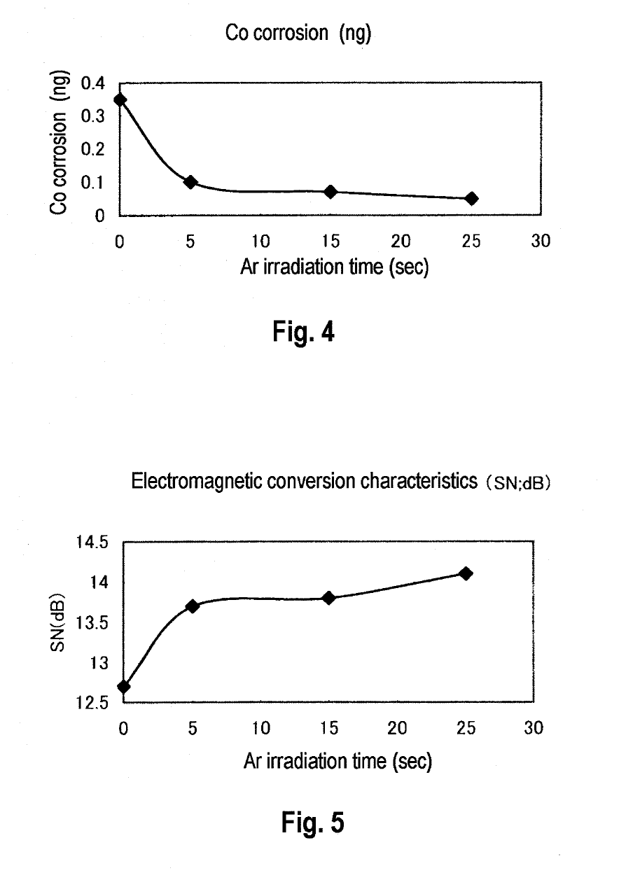

The corrosion of cobalt (ng) and the electromagnetic conversion characteristics (SN; dB) of the magnetic recording mediums manufactured in Examples 1 to 6 and Comparative Example 1 were evaluated as follows. The evaluation results are shown in Table 1 and FIG. 4 and FIG. 5.

Evaluation of Environmental Resistance

Environmental resistance, as expressed by corrosion (ng) of cobalt, of the magnetic recording mediums manufactured in the examples and the comparative example was evaluated as follows. Each magnetic recording medium was left to stand at a temperature of 80° C. and a relative humidity of 80% for 48 hours, and occurrence of corrosion on the surface of the magnetic recording medium was observed. More specifically 100 micro-liter of aqueous 3% nitric acid was dropped in each of ten spots on the surface of the magnetic recording medium. Then the magnetic recording medium was covered with a petri dish and left to stand for one hour. Then the drops on the magnetic recording medium were collected by using a pipet.

The content of cobalt in the collected drops was measured. The content (ng) of cobalt was shown as Co corrosion in Table 1 and a relation between Ar irradiation time and Co corrosion is shown in FIG. 4.

Evaluation of Electromagnetic Conversion Characteristics

Electromagnetic conversion characteristics (SNR; dB) of the magnetic recording mediums manufactured in the examples and the comparative example were evaluated as follows. A spin stand was used. SNR values and 3T-squash was measured upon recording a signal at 750 kFCl. A vertical recording head for recording and a TuMR head for loading were used as a head for the evaluation. SNR and 3T-squash were measured, and SNR is shown in Table 1 and a relation between Ar irradiation time and SNR is shown in FIG. 5.

TABLE 1

| | | |
|---|---|---|
| Inert gas irradiation | SNR | Co corrosion |

| | Element | Time (sec) | (dB) | (ng) |
|---|---|---|---|---|
| Com. Ex. 1 | — | 0 | 12.7 | 0.35 |
| Example 1 | Ar | 5 | 13.7 | 0.1 |
| Example 2 | Ar | 15 | 13.8 | 0.07 |
| Example 3 | Ar | 25 | 14.1 | 0.05 |
| Example 4 | He | 15 | 13.9 | 0.12 |
| Example 5 | Xe | 15 | 13.8 | 0.08 |
| Example 6 | Kr | 15 | 13.7 | 0.07 |

### INDUSTRIAL APPLICABILITY

According to the present invention, a magnetic recording medium having enhanced environmental resistance can be provided. Thus, a hard disk drive which can be used stably even under severe environmental conditions, such as, for example, a memory built in a car navigation system.

1. A process for manufacturing a magnetic recording medium having a magnetically partitioned magnetic recording pattern, characterized by comprising the following steps (1), (2) and (3), conducted in this order:
(1) a step of forming a magnetic layer on a non-magnetic substrate;
(2) a step of exposing the surface of regions of the magnetic layer to a reactive plasma or a reactive ion, which regions are to magnetically partition the magnetic layer for forming a magnetically partitioned magnetic recording pattern; and
(3) a step of exposing the thus-magnetically partitioned magnetic layer to an inert gas irradiation.

2. A process for manufacturing a magnetic recording medium having a magnetically partitioned magnetic recording pattern, characterized by comprising the following steps (1), (2), (3) and (4), conducted in this order:
(1) a step of forming a magnetic layer on a non-magnetic substrate;
(2) a step of removing surface layer portions of regions of the magnetic layer, which regions are to magnetically partition the magnetic layer for forming a magnetically partitioned magnetic recording pattern;
(3) a step of exposing the thus-exposed surface of regions of the magnetic layer, from which the surface layer portion thereof have been removed in step (2), to a reactive plasma or a reactive ion; and
(4) a step of exposing the thus-magnetically partitioned magnetic layer to an inert gas irradiation.

3. The process for manufacturing a magnetic recording medium according to claim 2, wherein the surface layer portions of said regions are removed by ion milling in step (2).

4. The process for manufacturing a magnetic recording medium according to claim 2 or 3, wherein the surface layer portions in said portions to be removed in step (2) have a thickness in the range of 0.1 nm to 15 nm.

5. The process for manufacturing a magnetic recording medium according to claim 1, wherein the surface of said regions of the magnetic layer is exposed to a reactive plasma or a reactive ion to an extent such that the magnetic characteristics of said regions of the magnetic layer regions are deteriorated.

6. The process for manufacturing a magnetic recording medium according to claim 5, wherein the deterioration of the magnetic characteristics is reduction of the coercive force and residual magnetization.

7. The process for manufacturing a magnetic recording medium according to claim 5, wherein the deterioration of the magnetic characteristics is caused by demagnetization or amorphization.

8. The process for manufacturing a magnetic recording medium according to claim 1, wherein the reactive plasma or the reactive ion contains an oxygen ion.

9. The process for manufacturing a magnetic recording medium according to claim 1, wherein the reactive plasma or the reactive ion contains a halogen ion.

10. The process for manufacturing a magnetic recording medium according to claim 9, wherein the halogen ion is a halogen ion formed by introducing a halide gas into a reactive plasma, said halide gas being at least one halide gas selected from the group consisting of CF₄, SF₆, CHF₃, CCl₄ and KBr.

11. The process for manufacturing a magnetic recording medium according to claim 1, wherein the inert gas used for the exposure to the inert gas irradiation is at least one inert gas selected from the group consisting of Ar, He and Xe.

12. The process for manufacturing a magnetic recording medium according to claim 1, wherein the exposure to the inert gas irradiation is carried out by a method using at least one means selected from the group consisting of ion gun, induced coupled plasma (ICP), and reactive ion plasma (RIB).

13. A process for manufacturing a magnetic recording medium having a magnetically partitioned magnetic recording pattern, characterized by comprising the following steps (1) through (8), conducted in this order:
(1) a step of forming a magnetic layer on a non-magnetic substrate;
(2) a step of forming a masking layer on the magnetic layer;
(3) a step of forming a resist layer on the masking layer;
(4) a step of forming on the resist layer a magnetic recording pattern for partitioning the magnetic layer into divided regions;
(5) a step of removing the masking layer and, if any, a residual resist layer, in the regions corresponding to the magnetic layer-partitioning regions in the magnetic recording pattern;
(6) a step of exposing the thus-exposed surfaces of magnetic layer, from which the masking layer and the residual resist layer in said regions of magnetic layer have been removed in step (5), to a reactive plasma or a reactive ion, whereby a magnetic recording pattern is formed which is magnetically partitioned by said regions of magnetic layer;
(7) a step of removing the whole residual masking layer; and
(8) a step of exposing said regions of magnetic layer to an inert gas irradiation.

14. A process for manufacturing a magnetic recording medium having a magnetically partitioned magnetic recording pattern, characterized by comprising the following steps (1) through (9), conducted in this order:
(1) a step of forming a magnetic layer on a non-magnetic substrate;
(2) a step of forming a masking layer on the magnetic layer;
(3) a step of forming a resist layer on the masking layer;
(4) a step of forming on the resist layer a magnetic recording pattern for partitioning the magnetic layer into divided regions;
(5) a step of removing the masking layer and, if any, a residual resist layer, in the regions corresponding to the magnetic layer-partitioning regions in the magnetic recording pattern;
(6) a step of removing the surface layer portions in said regions of the magnetic layer, from which the masking layer and the residual resist layer have been removed in step (5).
(7) a step of exposing the thus-exposed surface in the regions of the magnetic layer, from which the surface layer portion thereof have been removed in step (6), to a reactive plasma or a reactive ion, whereby a magnetic recording pattern is formed which is magnetically partitioned by said regions of magnetic layer;
(8) a step of removing the whole residual masking layer; and
(9) a step of exposing said regions of magnetic layer to an inert gas irradiation.

15. The process for manufacturing a magnetic recording medium according to claim 1, which further comprises a step of forming a protective overcoat over the exposed surface after the exposure of said regions of magnetic layer to an inert gas irradiation.

16. A magnetic recording reproducing apparatus characterized by comprising, in combination, the magnetic recording medium manufactured by the process as claimed in claim 1; a driving part for driving the magnetic recording medium in the recording direction; a magnetic head comprising a recording part and a reproducing part; means for moving the magnetic head in a relative motion to the magnetic recording medium; and a recording-and-reproducing signal treating means for inputting signal to the magnetic head and for reproduction of output signal from the magnetic head.
